(19) United States
(12) Patent Application Publication
(10) Pub. No.: US 2003/0131683 A1
(43) Pub. Date: Jul. 17, 2003

(54) Connecting rod for an internal combustion engine having a self-supporting integrated locking serration

(76) Inventor: Michael D. Glannone, Colorado Springs, CO (US)

Correspondence Address: DEBRA J. FICKLER, 12525 GRANDVIEW DRIVE, HUNTLEY, IL, 60142, US

(21) Appl. No.: 10/325,274

(22) Filed: Dec. 19, 2002

Related U.S. Application Data
(60) Provisional application No. 60/342,652, filed on Dec. 19, 2001.

(51) Int. Cl. G05G 1/00

(52) U.S. Cl. 74/579 R

(57) ABSTRACT

An advanced system for mating a connecting rod cap to the connecting body is provided. An integrated locking serration is utilized which provides increased multiple-dimension support to resist the bending and pulling forces experienced by a connecting rod during operation of the internal combustion engine.

This application claims priority to provisional U.S. application Ser. No. 60/342,652, filed Dec. 19, 2001.

### FIELD OF THE INVENTION

The invention relates to a connection rod for an internal combustion engine. More specifically, the invention relates to a self-supporting structure to ensure proper fit-up during the installation of the connecting rod in an engine and the method of manufacture thereof.

### BACKGROUND OF THE INVENTION

As used in automotive engines, an internal combustion engine creates the power to rotate a drive shaft that cooperates with a gear mechanism to create rotation of the automobile drive wheels. Conventional internal combustion engines utilize a combustion chamber typically called a cylinder that contains a piston and a connection rod that is connected to the piston at the connecting rod's “small” end and a crankshaft at the connecting rod's “big” end. The small end of the connecting rod utilizes a wrist pin and a busing to fix the piston to the rod. The big end, utilizes a removable “cap,” which is used to the connecting rod to the crankshaft at an area called the crankshaft journals. Semi-circular bushings with locating tabs are utilized on both the cap and the rod to reduce friction and absorb wear on the connection rod and the crankshaft. The connecting rod acts as the mechanism, which facilitates the conversion of linear motion, the up-and-down motion of the piston in the cylinder, into rotational motion, the turning of the crankshaft, which is translated through gears to the drive wheels of the automobile.

During the up stroke of the piston in the cylinder, an intake valve opens to allow fuel and air to enter the combustion chamber. Somewhere near the very top of this up stroke, both the intake and the exhaust valves close and the spark plug creates a spark to ignite the air-fuel mixture which is under compression by the piston. This results in a high temperature explosion which forces the piston downward, called the “power stroke,” thereby translating this movement via a connection rod to rotate the crankshaft which, in turn, translates this angular motion to the wheels of the vehicle via a set of gears. Near the bottom of the compression stroke, the exhaust valve opens to expel the burnt fuel mixture out of the cylinder. After the piston changes directions and begins the up stroke, the exhaust valve continues to remain open thereby forcing any remaining the spent gases out of the cylinder. However, during this same time, the intake valve begins to open to recharge the cylinder with fuel. It is not until the piston has started to travel upward that the exhaust valve closes. Thus, at various times during the compression cycle, both the intake and exhaust valves will be open and closed at the same time. The timing of the opening and closing of the valves is controlled by the physical design of the oval shaped lobes on the camshaft. In a conventional pushrod motor, as the valve lifter is pushed upward by the lobe of the camshaft, the valve lifter pushes the pushrod up which drives the rocker arm downward, causing the valve to open. Likewise, as the lifter and pushrod travel downward, the rocker arm raises and the valve closes due to the biasing action of the valve spring. Alternative, an overhead camshaft may be used to open and close the valves.

The connection rod must be strong enough to transmit the force exerted on the piston during the explosion of the fuel-air mixture in the cylinder to the crankshaft with minimal deflection or bending of the connecting rod. Traditionally, connecting rods are composed of high strength steel that is forged and has undergone a final machining process to ensure the proper geometry of the small and big ends of the rod. Although steel is an excellent material choice to maximize strength, rod life and minimize deflection, it is often not desirable for high performance engines due to its heavy weight.

In high performance engines where weight is extremely critical, often lighter weight aluminum is used. However, due to the fatigue property of aluminum and the extreme stress an aluminum rod is under in these higher performance, high RPM engines, the aluminum connecting rods are preferably machined out of billet aluminum. Moreover, it is also advantageous to finish the surface of the rod to reduce stress-raising imperfections. The aluminum rod material also creates a disadvantage in the treaded portion of the big end of the rod, which receives a high strength steel bolt to fix the rod cap to the rod. Convention method for creating the threads in the aluminum material do not provide the strength needed for these high performance engines and may result in catastrophic failure of the engine if the threads fail, at a cost of ten to hundred thousand dollars in engine damage. Therefore, aluminum connecting rod are often used for only a set number of engine operation hours or, as counted by drag racers, “passes.”

The big end of the rod must also resist twisting as the crankshaft rotates. To resist the twisting motion, the mating surfaces of the big end of the rod and rod cap are typically machined with serrations. Conventional serrations are usually parallel with the major axis of the crankshaft. One disadvantage of these serrations is that they are often deflected as the rod bolts are torqued creating distortion and potentially misalignment.

High performance engines are often disassembled to check for part wear or damage to the engine. One concern with connecting rods is to ensure that the used rods have not bent or twisted. Thus, the mechanic or engine builder must visually inspect the rod body for any deflection before reinstalling the rod. During the re-installation process, the mechanic or engine builder mates the rod body to the rod cap such that the peaks of the serrations on mating surface of the rod body mate with the valleys on the mating surface of the rod cap. The engine builder or mechanic will progressively torque the rod bolts and use feeler gages to ensure proper alignment and clearances between the rod and the adjacent crank counterweight or crank web. Although the serrations on the mating surfaces of the cap and rod body help position the two, the repeated disassembly and assembly may result in the changing of the these peaks and valleys. The aluminum material deforms a process called “cold flow.” A peak may flatten if it is not properly supported by a valley when the rod bolts are tights. Moreover, the pressure of tightening the rod bolts may also cause a peak to flatten and the material may squeeze out the sides of the rod. If the rod cap and rod body misalign as during the process of tightening the rod bolts, the distance between either the rod cap and rod the adjacent counterweight changes. The engine builder uses feeler gages of various thickness to ensure that these distances are the same. When they are, the cap and rod body are aligned. The process can take up to an hour. Although time consuming, this is an extremely important process to prevent future damage to the engine. This process is much faster when using rods made of steel alloy. The less ductile steel requires much greater forces to cause cold flow of the material. As such, the serrations typically match up much easier and the feeler gage process is usually very short with steel rods.

Likewise, the repeated assembly and tightening of the rod bolts can result the diameter of the housing bore of the big end of an aluminum rod to change. The over-tightening of the rod bolts may cause the big end to deflect resulting in an oval shape. After the rods have been removed from the engine, the engine builder will measure the diameter of the housing bore of the big end to determine if it has become out of round. If so, the engine builder must hone the housing bore to return its shape to round.

A bent connecting rod causes the piston to be out of center with the cylinder and will result in excessive wear of the piston, cylinder walls, piston wrist pin and the rod bearings. This misalignment may prevent the piston rings located around the top of the piston from properly seating against the cylinder. This may allow the exhaust gases to blow-by the rings or allow some of the air-fuel mixture to travel past the piston and contaminate the oil of the engine. Thus, if the connecting rod is bent or if the rod cap and rod body do not align, the rod must be replaced. This is more common with aluminum and titanium rods than less ductile steel rods. However, the rotational forces on the engine are great and even steel rods can fatigue leading to bending of the rod or rod failure.

Another concern in internal combustion engines is ensuring sufficient oiling to the bearings of the connecting rod. Often an oiling hole is machined at the small end of connecting rod to allow oil to travel to the wrist pin in the small end. Another concern is the oiling of the bearing at the big end of the connecting rod. One method of providing oil to the big end is to machine an oiling channel from the small end through the major axis of the rod to the big end. However, this becomes extremely difficult in rods that have minimal thickness due to the desire to reduce weight and may comprise the strength of the rod.

With all of these demands on the connecting rod of a high performance engine, the conventional connecting rod designs and manufacturing processes are insufficient.

Even at low engine speeds such as those seen during idling, start-up, stop-and-go driving conditions, and gear shifting also create inadequate lubrication conditions and increases the stresses and forces on the connecting rods. Not only are these types of driving conditions prevalent on race day, but also seen during every day driving. Therefore, a high strength, low weight connecting rod with sufficient oiling and wear property is needed to reduce wear, maximize engine performance and avoid premature component failure.

### BRIEF SUMMARY OF THE INVENTION

In a first embodiment of the invention, an integrated locking serration having concentric arcs are used on the mating surfaces on the connection rod body and the rod cap. The corresponding peak and valley mate directly to prevent rotation or twist of the rod cap during installation and during operation, the surfaces prevent the cap from twisting due to the rotational forces acting on the big end of the connecting rod. The

In a second embodiment of the invention, an intergraded locking serration have the shape of a pyramid is utilized to on the mating surfaces of the rod body and corresponding rod cap.

In a third embodiment of the invention utilizes a concentric circular integrated locking serrations on the mating surfaces of the rod body and corresponding rod cap. The integrated locking serrations are self-supporting across the mating surfaces of the rod cap and rod body. This improvement virtually eliminates the need to use feeler gages to ensure that the cap and body hare perfectly aligned. Moreover, this concentric circular integrated locking serration design prevents the cold flow of aluminum material as the rod cap is mated with the rod body during installation of the connecting rod.

### BRIEF DESCRIPTION OF THE DRAWINGS

FIG. 1 is a broken-away side view of an internal combustion engine showing a crankshaft, connection rods, pistons, valves, and overhead camshaft;

FIG. 2 is a perspective view of a connecting;

FIG. 3 is an exploded perspective view of a connecting showing the body, rod cap and rod bolts;

FIG. 4 is a front elevation view of a connecting rod;

FIG. 5 is a side elevation view of a connecting rod;

FIG. 6 is a top plan view of the connecting rod with the rod cap removed illustrating the prior art parallel serrations;

FIG. 7 is a sectional view taken along lines 7 of FIG. 6 illustrating the prior art parallel serrations;

FIG. 8 is a bottom plan view of the rod cap showing the prior art parallel serrations;

FIG. 9 is a sectional view taken along lines 9 of FIG. 8 illustrating the prior art parallel serrations;

FIG. 10 is a sectional view taken along lines 10 of FIG. 4 showing the mating of the prior art parallel serrations of the rod cap to the rod body;

FIG. 11 is an exploded sectional view taken along lines 10 of FIG. 4 illustrating the mismatching of peak and valleys of the rod cap and rod body;

FIG. 12 is a sectional view taken along lines 10 of FIG. 4 showing the resulting cold flow of the serration material on the mating surfaces of the rod cap and rod body;

FIG. 13 is a top plan view of the connecting rod with the rod cap removed illustrating concentric arc serrations;

FIG. 14 is a sectional view taken along lines 14 of FIG. 13 illustrating the concentric arc serrations;

FIG. 15 is a bottom plan view of the rod cap showing the concentric arc serrations;

FIG. 16 is a sectional view taken along lines 16 of FIG. 15 illustrating the concentric arc serrations;

FIG. 17 is a sectional view taken along lines 10 of FIG. 4 showing the mating of the concentric arc serrations of the rod cap to the rod body;

FIG. 18 is a sectional view taken along lines 10 of FIG. 4 showing the cold flow of material at the edges of the concentric arc serrations of the rod cap and rod body;

FIG. 19 is a top plan view of the connecting rod with the rod cap removed illustrating frusto-pyramidal serrations;

FIG. 20 is a sectional view taken along lines 20 of FIG. 19 illustrating the frusto-pyramidal serrations;

FIG. 21 is a bottom plan view of the rod cap showing the, frusto-pyramidal serrations;

FIG. 22 is a sectional view taken along lines 22 of FIG. 21 illustrating the frusto-pyramidal serrations;

FIG. 23 is a sectional view taken along lines 23 of FIG. 19 illustrating the frusto-pyramidal serrations;

FIG. 24 is a sectional view taken along lines 24 of FIG. 21 illustrating the frusto-pyramidal serrations;

FIG. 25 is a sectional view taken along lines 10 of FIG. 4 showing the mating of the frusto-pyramidal serrations of the rod cap to the rod body;

FIG. 26 is a sectional view taken along lines 26 of FIG. 5 showing the mating of the frusto-pyramidal serrations of the rod cap to the rod body;

FIG. 27 is a sectional view taken along line 10 of FIG. 4 showing the cold flow of material of material at the edges of the frusto-pyramidal serrations of the rod cap to the rod body;

FIG. 16 is a top plan view of the connecting rod with the rod cap removed illustrating concentric circular serrations;

FIG. 17 is a sectional view taken along lines 17 of FIG. 16 illustrating the concentric circular serrations;

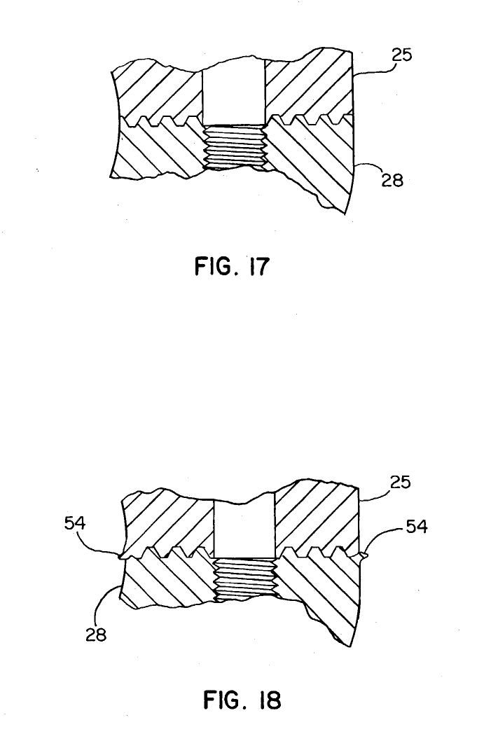

FIG. 18 is a bottom plan view of the rod cap showing the concentric circular serrations;

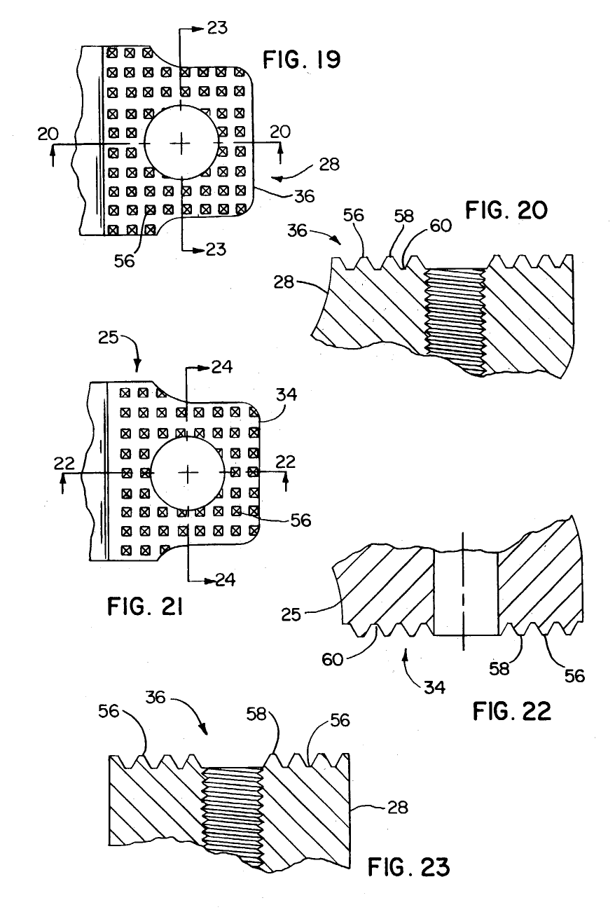

FIG. 19 is a sectional view taken along lines 18 of FIG. 18 illustrating the concentric circular serrations;

FIG. 20 is a sectional view taken along lines 10 of FIG. 4 showing the mating of the concentric circular serrations of the rod cap to the rod body;

### DETAILED DESCRIPTION OF THE INVENTION

Connecting rods used in high performance engines such as those for drag racing applications are preferably lightweight, but must be strong enough to survive the forces placed on the rod during the combustion process. Likewise, the mating surfaces of the rod cap to tire rod body must be able to withstand the rotation and linear forces placed on the rod at these mating surfaces. A self-supporting, integrated locking serration is disclosed which provides increased strength to the mating area to securely hold the rod cap and body and aids in resisting the great twisting and pulling forces the connecting rod experiences during operation of the high performance engine. The invention may be embodied in various forms of integrated locking serrations.

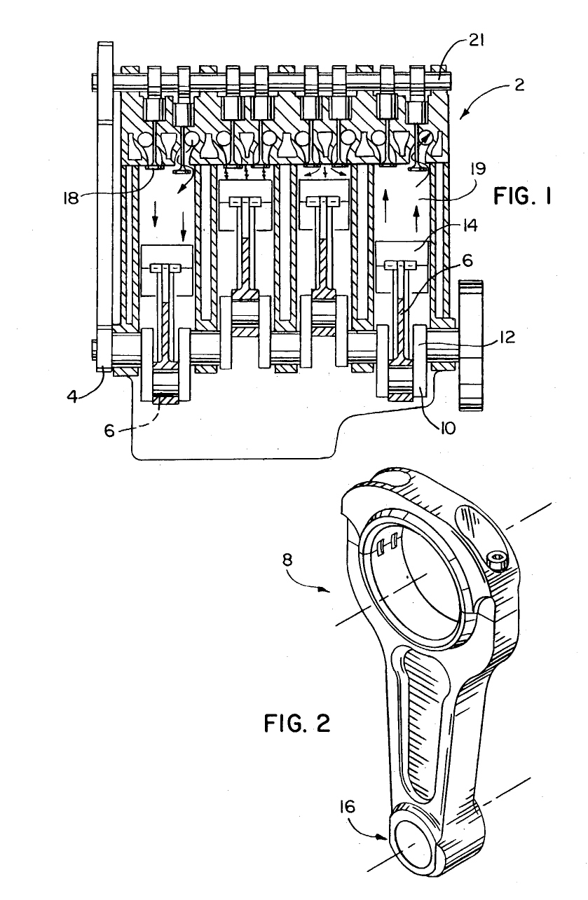

FIG. 1 illustrates a conventional internal combustion engine 2. A crankshaft 4 is located near the bottom of the engine and contains journals 6 for which a connecting rod 8 is fixed to. In between each connecting rod 8 is a crank webs 10 that also contains a counterweight 12. Connecting rod 8 is illustrated in FIG. 2. Connecting rod 8 may be composed of aluminum, titanium or steel that may be manufactured using forged material having surface finishing machining or machined entirely from billet material. Each connecting rod 8 has a piston 14 fixed to it at the top of rod 8 referred to as the “small end” 16. At the top of the combustion chamber is a series of valves 18. Each combustion chamber 20 will have at least two valves 18, one called the intake valve 18 which, when opened, allows air and fuel to enter combustion chamber 20. The second valve 18, the exhaust valve 18, allows the waste products from the explosion of the air-fuel mixture to exit combustion chamber 20. Various engine designs may contain a more that one set of valves 18 per combustion chamber 20. The opening and closing of valves 18 are controlled by a camshaft 21 shown in FIG. 1 which illustrates an over-head cam engine design. Often high performance engines will utilize push rods that translate the motion of camshaft 21 to a rocker arm (not shown) which in turn, cooperates with a valve stem to open and close the valves 18.

As seen in FIG. 1. pistons 14 move up and down as a result of the combustion of the gases in combustion chamber 20, and connecting rod 8 translates this motion to crankshaft 4. The timing of the combustion in each of the combustion chambers 20 is such that as rods 8 travel up and down, they translate this linear energy into rotational energy of crankshaft 4.

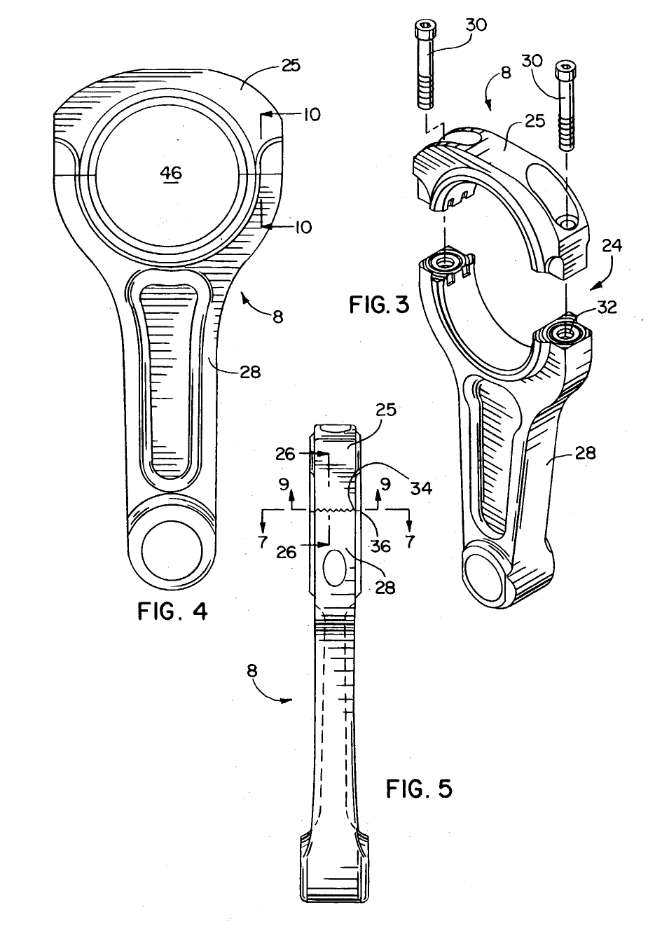

Turning to FIG. 3, connecting rod 8 contains a larger end refer to as the “big end” 24 which receives crankshaft journal 6. Big end 24 contains a rod cap 25 which mates to rod body 28. High strength bolts 30 are used to hold the rod cap 25 to rod body 28, which also contains a threaded hole 32 to receive high strength bolts 30. FIG. 4 shows connecting rod 8 with rod cap 25 fixed to the rod body 28. As shown in FIG. 5, the mating surface 34 of rod cap 25 and mating surface 36 of rod body 28 are seen as a break in the profile of connecting rod 8.

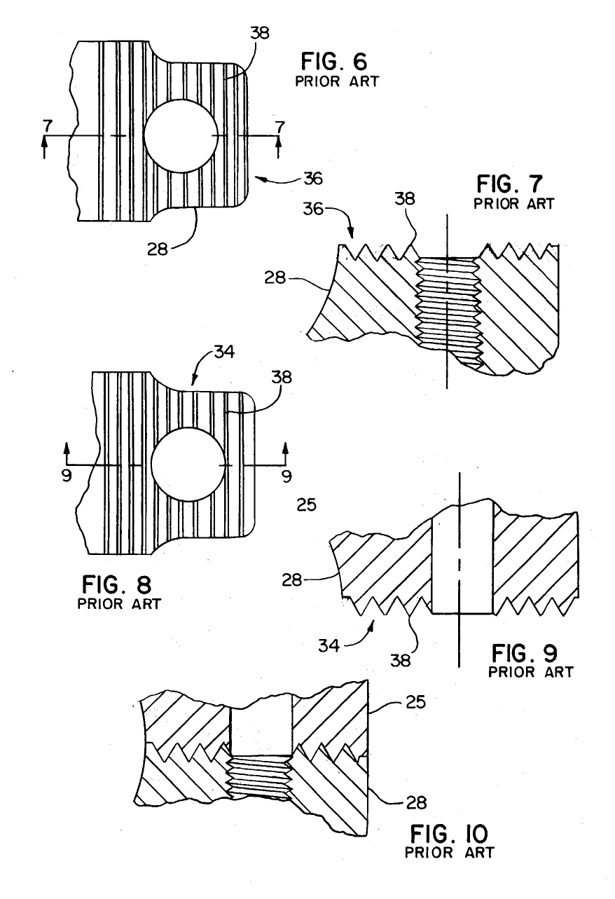

FIG. 6 illustrates conventional, prior art parallel serrations 38 which are machined on mating surface 36 of rod body 28 used on aluminum and titanium connecting rods; steel connecting rods typically do not utilize multiple serrations. As shown in FIG. 6, prior art serrations 38 are seen as a series of lines running in one direction, the “y” direction as shown in the figure. FIG. 7 is a cross-section taken along line 7 in FIG. 6. Prior art serrations 38 appear as a series of pointed-peaks and valleys along mating surface 36. FIG. 8 shows the mating surface 34 of rod cap 25 and prior art serrations 38. FIG. 9 is a cross sectional view taken along line 9 of FIG. 8 showing mating surface 34 of rod cap 25. FIG. 10 is a cross section view of the assembled rod cap 25 and rod body 28. As seen in FIG. 10, the mating surface 34 of rod cap 25 and mating surface 36 of rod body 28 must be machined such that a valley of the prior art serration 38 receives a peak. This creates a two-dimensional bonding surface. This configuration assists in resisting the twisting forces the big end of the connecting rod experiences during combustion.

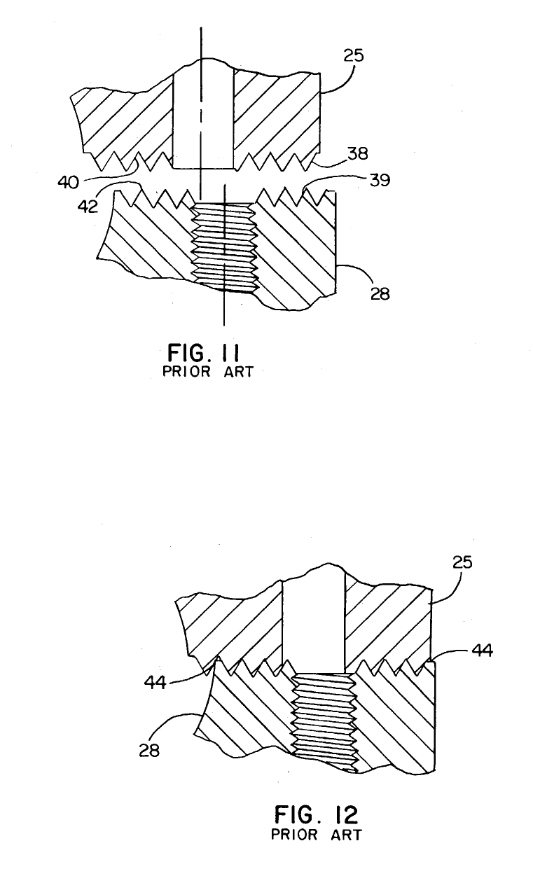

During the installation of connecting rod 8 in engine 2, half of a solid bearing (not shown) is press-fit in rod cap 25 and the other half is placed in big end 24 of rod body 28. The big end 24 of connecting rod 8 is then positioned on crankshaft 4 and held in place using rod cap 25. For proper installation, a valley 40 of prior art serrations 38 on rod cap 25 aligns with a peak 42 of prior art serration 38 of rod body 28. FIG. 11 illustrates an inadequacy of the design of prior art serration 38. A peak 42 of a prior art serration 38 may align with the incorrect correspond valley 40 as shown in FIG. 11. Due to the hardness of high strength steel rod bolt 30, bolt 30 may enter treaded hole 32 and cold form the threads. Likewise, the serrations 38 at the end of the edges of the rod cap 25 and rod body 28 deform as high strength steel bolt 30 is tightened as shown in FIG. 12. These deformed serrations 44 have under going cold forming. Thus, during assembly, the engine builder must check the alignment of rod cap 25 and rod body 28 of each connecting rod 8 in engine 2 using feeler gages between connecting rod 8 and crank web 10. The engine builder must check the alignment and torque high strength steel rod bolt 30 and then move to another connection rod 8 and continue this progression of tightening rod bolts 30 and checking alignment with the feeler gages. This process may take an hour or longer to complete.

Improper installation may result in the peaks 42 and valleys 40 of the mating surfaces 34 and 36 to be improperly positioned during assembly and all of the prior art serrations may cold form across mating surface surfaces 34 and 36. This may lead to the circular opening of big end 24 as kwon as the housing bore 46, to become out of round (see FIG. 4) when high strength rod bolts 30 are tightened. If high strength rod bolts 30 are over tightened rod cap 25 and the upper portion of rod body 28 deforms due to cold forming of the aluminum resulting in an oval shaped housing bore 46. If the diameter of housing bore 46 is incorrect, the engine builder must housing bore 46 until it is back to round. Another disadvantage of prior art serration 38, is that during operation of engine 2, it believed that rod cap 25 moves back and forth in the “y” direction of prior art serration 38. This movement contributes to cold forming of big end 24. Likewise, this adds to wear of journal 6 of crankshaft 4. This siding motion of rod cap 25 may increase the twisting forces on rod 8 during operation. Although journal 6 is treated with a wear surface coating such as chromium or cadmium plating, the movement of rod cap 25 will increase the wear of journal 6 and the bearing of rod 8. When these components wear, material is removed from one or both bearing surfaces. These small flecks of material contaminate the engine oil and travel to combustion chamber 19. From here the material may be dragged along the wall of combustion chamber 19 by piston 14. Eventually, a groove will ear into the combustion chamber wall which may let exhaust gases or the air-fuel mixture to escape combustion chamber 19. This can lead to predetonation of the air-fuel mixture and catastrophic failure of engine 2.

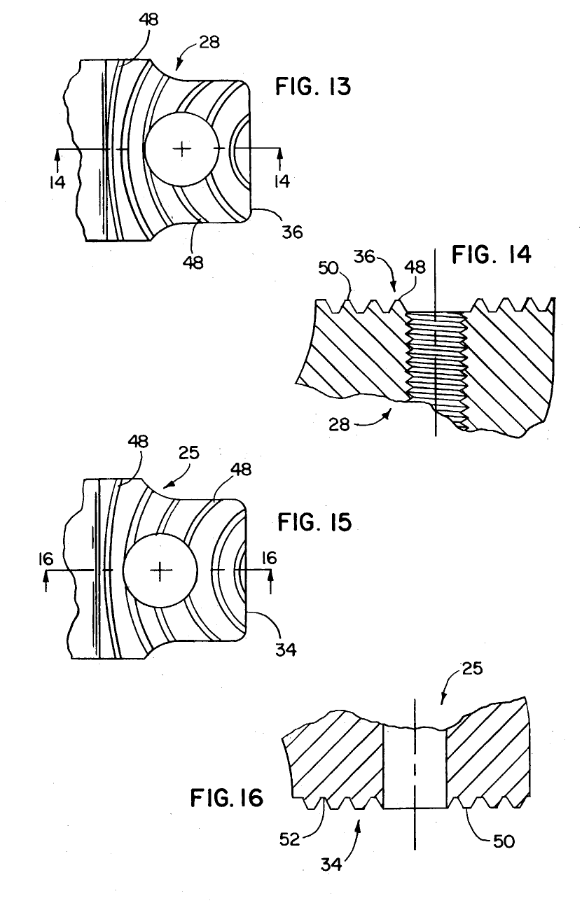

One embodiment of the integrated locking serrations uses concentric arcs 48 to create a multiple dimensional mating surface as shown in FIGS. 13 through 16. Each concentric arc 48 has its own radius such that the radius of each concentric arc 48 increases as the move across rod body mating surface 36 as shown in FIG. 13. FIG. 14 is a cross-section of rod body 28 along line 14 of FIG. 13 illustrating rod body mating surface 36. Concentric arc serrations 48 have flattened peaks 50 and flattened valleys 52 as shown in FIG. 14. The corresponding and opposite concentric arc serrations 48 of rod cap 25 are shown in FIG. 15. Similarly, the cross-section of rod cap mating surface 34 is shown in FIG. 16. As with the prior art serration design shown in FIG. 7 through 10, a flattened peak 50 of concentric arc serration 48 of rod body 28 must be received by the flattened valley 52 of concentric arc serration 48 of rod cap 25 having the same radius as that of the rod body concentric arc serration 48. One advantage of concentric arc serrations 48 is that only one flattened peak of rod cap 25 can be received by one flattened valley 52 of rod body 28. A cross-sectional view of rod cap mating surface 34 and rod body mating surface 36 is shown in FIG. 17. Concentric arc serrations provide support in three dimensions providing integrated locking serrations.

The concentric arc integrated locking serrations reduced the assembly time by practically eliminating the need to check rod cap 25 and rod body 28 alignment with feeler gages. This is especially true during the first few assembly and disassembly of connecting rod 8. One disadvantage of concentric arc serrations 48 is that serrations 48 at the edges 54 of rod cap 25 and rod body 28 may deform after repeated tightening of high strength steel rod bolts 30 because the outer most serration is not supported by a corresponding serration as shown in FIG. 18. Any misalignment may also result is other concentric arc serrations 48 to deform. A second disadvantage of the concentric arc serration 48, is that the housing bore may still lose its shape and become out of round due to over tightening of high strength steel rod bolts 30.

A second embodiment of the integrated locking serration is shown in FIGS. 19 through 26. This embodiment utilizes a pyramid-shaped serration with the pointed tips of the pyramid truncated or removed such that the shape is frusto-pyramidal serration 56 is formed. The rod body mating surface 36 of rod body 28 is shown in FIG. 19. The frusto-pyramidal serrations 56 as shown in FIG. 19 looking down on rod body mating surface 36 as a checkerboard. Unlike the prior art serrations 44 which have two side surfaces that extend up and down in the “y” direction of mating surface 36 (see FIG. 6), the frusto-pyramidal serration 56 has four sides. A cross section showing the side along the “x” direction is in FIG. 20. An upward extending frusto-pyramidal side portion 58 and an inward frusto-pyramidal side portion 60 are illustrated in FIG. 20. Rod cap mating surface 34 also contains frusto-pyramidal serrations 56 a shown in FIG. 21. A corresponding inward extending frusto-pyramidal serration portion 60 on rod cap mating surface 34 mates with the corresponding outward extending frusto-pyramidal serration portion 56 on the rod body mating surface 36. A cross-section of frusto-pyramidal serration illustrating the side of frusto-pyramidal serration 56 in the “x” direction is shown in FIG. 22. Unlike the prior art serrations 38 shown in FIGS. 6-10, the frusto-pyramidal serration 56 has a side in the “y” direction. A cross section of the “y” side of frusto-pyramidal serration 56 of rod body mating surface 36 is shown in FIG. 23. Likewise, the “y” side of the frusto-pyramidal serration 56 has both outward extending frusto-pyramidal side portions 58 and inward extending frusto-pyramidal side portions 60. A cross sectional view of frusto-pyramidal serrations 56 on rod cap mating surface in the “y” direction are shown in FIG. 24. Also illustrated are the frusto-pyramidal serrations 56 with outward extending frusto-pyramidal side portions 58 and inward extending frusto-pyramidal side portions 60.

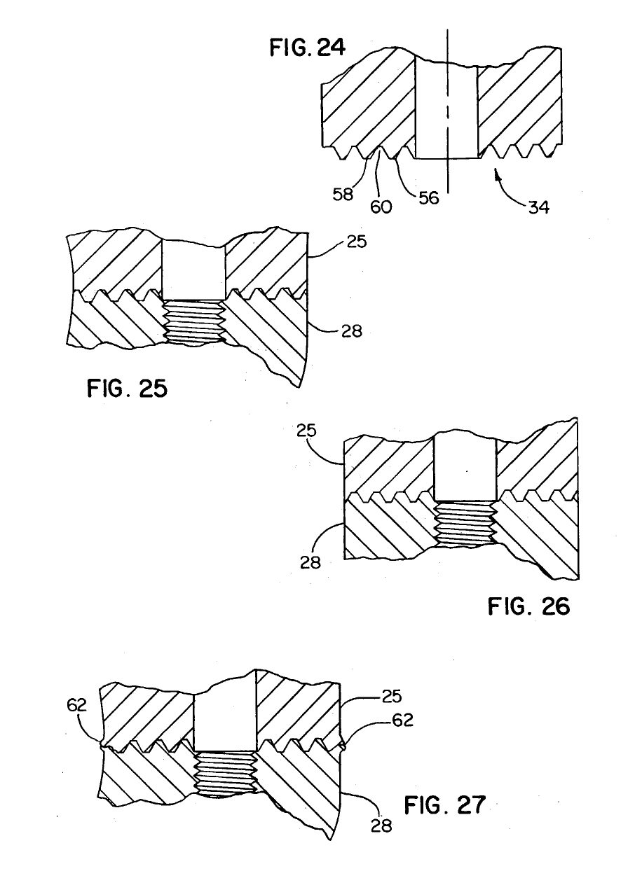

A cross-section view of the mated rod cap 25 and rod body 28 taken along line 10 of FIG. 4, is shown in FIG. 25. Each outward extending portion of frusto-pyramidal serration 56 on rod cap mating surface 34 is supported by a corresponding inward extending frusto-pyramidal serration 60 in this “x” direction. Likewise, a cross-sectional view of the rod cap mating surface 34 and rod body mating surface 36 rotated by 90 degrees as taken along line 26 of FIG. 5 is shown in FIG. 26. As seen in FIG. 26, each outward extending frusto-pyramidal side portion 58 on rod cap mating surface 34 is received by an inward extending frusto-pyramidal side portion 60 of rod body mating surface 36.

Frusto-pyramidal serrations 56 are integrated locking serrations due to the three-dimensional mating surfaces. The frusto-pyramidal serrations 56 resist twisting as rod 8 translates up and down. The installation of rods having the frusto-pyramidal serrations 56 are easier to install than those with the prior art serrations 38. Once rod cap 25 is positioned on rod body mating surface 36, the three-dimensional mating surface of frusto-pyramidal serrations 56 prevents the rod cap 25 from moving as the high strength steel rod bolts 30 are tightened. Although the frusto-pyramidal serration is an excellent design for mating the proper alignment of the rod components during rod 8 installation and for maintaining the house bore 46 diameter of big end 24, this serration design has two drawbacks. First, this multidimensional serration design requires four separate machining steps to create the two “x” sides and the two “y” sides pyramid and a fifth machining step to truncate the top of the pyramid. Likewise, this five step machining process must be repeated on the corresponding mating surface once the proper alignment has been determined.

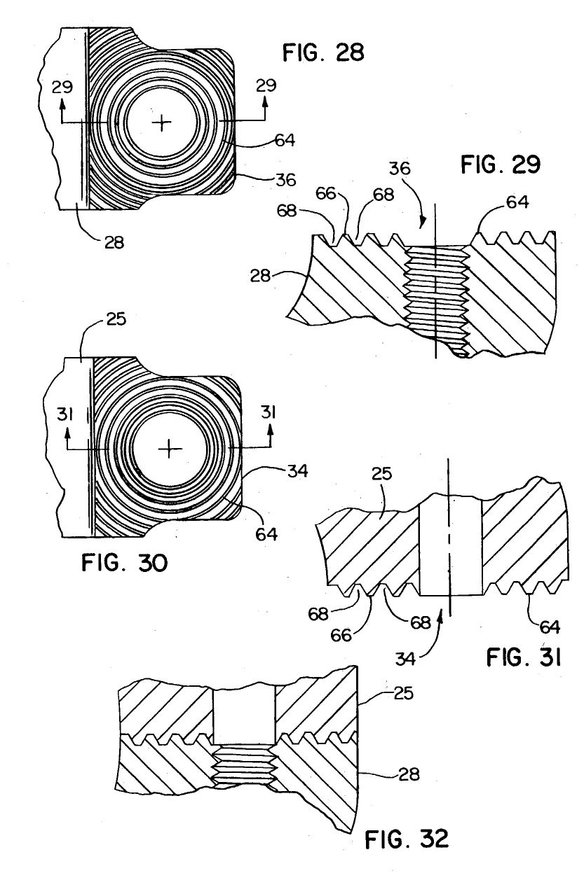

Second, the single-sided supported frusto-pyramid serrations 56 at the edges of rod cap mating surface 34 and rod body mating surface 36 may deform. Deformed frusto-pyramidal serration 62 is shown in FIG. 27. These serrations may deform because the serration is supported by a corresponding serration on the opposite mating surface. Thus, these outer frusto-pyramidal serrations 56 support the surfaces as if it were a prior art serration 38.

A third and preferred embodiment of the integrated locking serrations shown in FIGS. 28 through 32. The preferred embodiment utilizes raised concentric circle serrations 64 as shown in FIG. 28. As seen in the second embodiment utilizing the frusto-pyramid serration, the concentric circle serration 64 provides three-dimensional support. FIG. 28 illustrates the concentric circles serrations 64 on the rod body mating surface 38. The radius of each circle increases as the circles serrations 64 extend over rod body mating surface 38. A cross sectional view of the concentric circular serrations 64 taken along line 29 of FIG. 28 is shown in FIG. 29. An Outward extending concentric circle serration 66 is always adjacent to an inward extending concentric circle serration 68. Although the cross section shown in FIG. 29 appears similar to that of the prior art serration 38 of FIG. 7, each concentric circle serration 66 transverse the entire plane of the rod body mating surface 38. The rod cap mating surface 34 also utilizes concentric circle serrations 64 which are opposite in direction, outward extending verses inward extending, of those of rod body mating surface 36 as shown in FIG. 30. A cross sectional view of the rod cap mating surface 34 taken along line 31 of FIG. 30 is shown in FIG. 31. Concentric circle serrations 64 of rod cap mating surface 34 also displays the outward extending concentric circle serrations 66 which are adjacent to inward extending concentric circle serrations 68. FIG. 32 is a cross sectional view taken along line 10 of FIG. 4 showing rod cap 25 mated with rod body 28. As seen in FIG. 32, outward extending concentric circle serration 66 of rod cap 25 is held in inward extending concentric circle serration 68.

Preferred embodiment concentric circle serrations 64 as shown in FIGS. 28 through 32, are self-supporting providing an integrate locking serration system. Misalignment of rod cap 25 and rod body 28 cannot occur with the concentric circle serration 64 because each circle has a different diameter. Moreover, the concentric circle serration system strongly resists any twisting of the rod because each serration is supported in all three dimensions. The concentric circle serration 64 closest to high strength steel rod bolt 30 on rod cap 25 is supported by the opposing concentric circle serration 64 on rod body 28. Each concentric circle serration 64 as they move radially across rod body mating surface 36 is supported by a corresponding concentric circle serration 64 on rod cap mating surface 34. This design prevents the cold flow of the metal alloy of rod 8. This design eliminates the need to use feeler gages during the assembly of engine 2 and thereby, reduces assembly time by up to an hour. The concentric circle serration 64 also reduced wear of journal 6 of crankshaft 4 by eliminating the siding motion of rod cap 25 in the “y” direction of the prior art serration 38

While the invention has been described with respect to specific examples including presently preferred modes of carrying out the invention, those skilled in the art will appreciate that there are numerous variations and permutations of the above described systems and techniques that fall within the spirit and scope of the invention as set forth in the appended claims.

I claim:

1. A connecting rod for an internal combustion engine, the connecting rod having a body and a cap, the connecting rod comprising:
a first mating surface on the body;
a second mating surface on the cap;
a first serration on the first mating surface; and
a second serration on the second mating surface for receiving the first serration on the first mating surface wherein the second serration is completely supported by the first mating surface.

2. The connecting rod of claim 1 wherein the first serration protrudes out of the plane of the first mating surface and the second serration extends inward into the place of the second mating surface.

3. The connecting rod of claim 2 where in the first serration has the shape of an arc and the second serration has the shape of an arc.

4. The connecting rod of claim 2 wherein the first serration has the shape of a frusto-pyramid and the second serration has the shape of a frusto-pyramid.

5. The connecting rod of claim 2 wherein the first serration has the shape of a circle and the second serration has the shape of a circle.

6. A connecting rod for an internal combustion engine, the connecting rod having a body and a cap, the connecting rod comprising:
a first mating surface on the body;
a second mating surface on the cap;
a first and at least a second serration on the first mating surface; and
a third and at least a forth serration on the second mating surface for receiving the first and at least second serrations on the first mating surface wherein the third and the at least fourth serrations are completely supported by the first mating surface.

7. The connecting rod of claim 6 wherein the first and the at least second serrations protrude out of the plane of the first mating surface and the third and the at least forth serration extend inward into the plane of the second mating surface.

8. The connecting rod of claim 7 where in the first and the at least second serration has the shape of an arc and the third and the at least forth serration has the shape of an arc.

9. The connecting rod of claim 7 wherein the first and the at least second serration has the shape of a frusto-pyramid and the third and the at least forth serration has the shape of a frusto-pyramid.

10. The connecting rod of claim 7 wherein the first and the at least second serration has the shape of concentric circles and the third and the at least forth serration has the shape of a concentric circles.

11. A connecting rod for eliminating the movement of a connection rod cap with respect a connecting rod body and having a hole in the rod cap for receiving a rod bolt and a rod body with a corresponding threaded hold for receiving and gripping the rod bolt for holding the rod cap to the rod body, the connecting rod comprising:
a first outward protruding annular circle about the hole of the rod cap; and
a second inward protruding annular circle about the threaded hole of the rod body for receiving the first outward protruding annular circle surface wherein the outward protruding annular circle is completely supported by the inward protruding annular circle.
